(19) United States
(12) Patent Application Publication
(10) Pub. No.: US 2016/0027395 A1
(43) Pub. Date: Jan. 28, 2016

(54) DISPLAY APPARATUS, DRIVING METHOD THEREOF AND SCREEN APPARATUS FOR DISPLAYING

(71) Applicant: PIONEER CORPORATION, Kanagawa (JP)

(72) Inventor: Toshihiro YOSHIOKA, Kanagawa (JP)

(21) Appl. No.: 14/852,962

(22) Filed: Sep. 14, 2015

Related U.S. Application Data
(63) Continuation of application No. 14/386,878.

(51) Int. Cl. G09G 3/36; G09G 5/18; G09G 3/20

(52) U.S. Cl. CPC G09G 3/3674; G09G 3/2011; G09G 5/18; G09G 3/3648

(57) ABSTRACT

To reduce the image quality degradation, which emerges when an image light is projected on a screen which is controlled its optical state by the unit of the segmented regions. A display apparatus 1 includes: a screen 1 having an optical layer 25 and control electrodes 27 arranged on the optical layer 25 to be spaced from each other; a projector 11 projecting an image light to the screen 21; and a synchronous controller 31 that controls application of voltages to the control electrodes 27 to switch the optical state of each of the segmented regions from a nonvisual state to a visual state. The control electrode 31 applies the voltages with the same polarity to two control electrodes 27 arranged next to one another, when the gap region 28 of the space is irradiated with the image light.

### TECHNICAL FIELD

The present invention relates to a display apparatus, a driving method of the display apparatus, and a screen apparatus for displaying.

### BACKGROUND ART

There has been known a display apparatus that projects an image light on a screen and displays the projected image on the screen. As a kind of modulation devices, a liquid crystal modulation device is known which can control its transmittance (Patent Literature 1).

### CITATION LIST

### Patent Literature

### PTL1: Japanese Patent Application Laid-Open No. 2007-219419

### SUMMARY OF INVENTION

### Technical Problem

Here, a modulation screen may be thought and formed with the technology of the liquid crystal modulation devices, and this modulation screen may be used as an image displaying screen.

Further, in the imaginary display apparatus, a plurality of control electrodes may be arranged side by side on one surface of the screen, and a configuration is possible to control the optical state of the screen by the unit of the segmented region corresponding to each of the control electrodes. In the example, the segmented regions in the screen for displaying the image are controlled to be placed in the scattering state, and the other segmented regions are controlled to be placed in the transparent and transmitting state in which the degree of the scattering of the incident light is small. In this case, it is possible to control the screen to be placed in a see-through state in the projection period of the image light. That is, it is possible to display and overlay the displaying image and the back side image of the screen, on the screen.

However, in this configuration to provide the plurality of control electrodes on the screen and to control the optical state of the screen by the unit of the segmented region, the displayed image on the screen is likely to be deteriorate. That is, the plurality of segmented regions are required to be controlled by individual voltages. Moreover, the plurality of segmented regions are required to be separated from each other on one surface of the screen. There are gaps formed between two segmented regions next to one another. Therefore, even when each of separated voltages is applied to each of the control electrodes in the scanning period of the image light, it is difficult to control the gap region between these two segmented regions in the same optical state with that of the central portion of each of the control electrodes. As a result, the displayed image is distorted in the gap regions.

As described above, for the imaginary display apparatus, there is a demand to reduce the image quality degradation of the displayed image, which is caused when the plurality of control electrodes are arranged on the screen and the optical state of the screen is controlled by the unit of the segmented region corresponding to each of the control electrodes.

### Solution to Problem

The invention recited in claim 1 is a display apparatus comprising: a screen having an optical layer whose optical state is changed by applying a voltage and a plurality of control electrodes arranged side by side and spaced therebetween along the optical layer to apply the voltage to the optical layer; a projector configured to project image light on the screen to display an image; and a controller configured to apply the voltage to the plurality of control electrodes, to switch the optical state of the screen by the unit of each of segmented regions corresponding to the each of the control electrodes, between a predetermined visual state in which the image light is scattered and a nonvisual state which is different from the visual state, in a projection period of the image light, wherein, at a irradiation timing of the image light, the controller applies voltages with a same polarity to two of the control electrodes arranged next to one another, to control the optical state of a region between the two segmented regions.

The invention recited in claim 8 is a method of driving a display apparatus configured to display an image formed by image light irradiated from a projector, on a screen having an optical layer whose optical capability is changed by applying a voltage, the display apparatus including a controller that controls an optical state of the screen by: applying the voltage to a plurality of control electrodes arranged side by side and spaced from each other along the optical layer, to display the image formed by the image light on the screen which has the plurality of control electrodes; switching the optical state of the screen between a predetermined visual state to scatter the image light and a nonvisual state which is different from the visual state, by the unit of the segmented regions in accordance with the control electrodes, in the projection period of the image light; controlling application and termination of the application of the voltages to the plurality of control electrodes in a scanning period of the image light, by switching each of states of the segmented regions corresponding to the control electrodes with the voltage applications, from a visual state in which the image light is scattered to a predetermined nonvisual state which is a different optical state thereof; and, at an irradiation timing of the image light, applying the voltages with a same polarity to two control electrodes arranged next to one another, to control the optical state of a region between the two segmented regions.

The invention recited in claim 9 is a screen apparatus for displaying comprising: a screen configured to display an image formed by projecting image light, the screen having an optical layer whose optical capability is changed by applying a voltage; and a plurality of control electrodes arranged side by side and spaced from each other along the optical layer to apply the voltage to the optical layer; and a controller configured to apply and stop of the voltage to the plurality of control electrodes, and to switch the optical state of each of segmented regions corresponding with the control electrodes, between a predetermined visual state in which the image light is scattered and a nonvisual state which is different from the visual state, wherein, at an irradiation timing of the image light, the controller applies the voltages with a same polarity to two control electrodes arranged next to one another to control the optical state of a region between the two segmented regions.

### BRIEF DESCRIPTION OF DRAWINGS

FIG. 1 is a schematic view showing the configuration of a display apparatus according to Embodiment 1 of the present invention;

FIG. 2 is a drawing explaining synchronous control between the scanning and the driving of a screen;

FIG. 3 is a drawing explaining a projector which continuously projects a plane image;

FIG. 4 is a drawing explaining another projector which projects a planar image in a time modulated way;

FIG. 5 is a drawing explaining another projector which scans the screen;

FIG. 6 is a schematic cross-sectional view of a screen;

FIG. 7 is a schematic front view of the screen to show the array of a plurality of control electrodes;

FIG. 8 is a schematic timing chart showing the scanning and the driving of the screen;

FIG. 9 is a drawing explaining an overlaid displaying state of an image formed by image light and a back side image of the screen;

FIG. 10A is a drawing explaining an electric field distribution which influences the optical state of the gap region between two segmented regions;

FIG. 10B is a drawing explaining another electric field distribution which influences the optical state of the gap region between two segmented regions;

FIG. 11 is a schematic timing chart showing the relationship between the optical states of a plurality of segmented regions and the driving voltage waveforms according to Embodiment 1;

FIG. 12 is a schematic timing chart showing the relationship between the optical states of the plurality of segmented regions and the driving voltage waveforms according to Comparative example 1;

FIG. 13A is a drawing explaining a line inversion control of Embodiment 2 in which the driving voltage waveforms are applied to the plurality of control electrodes;

FIG. 13B is a drawing explaining another line inversion control of Embodiment 2 in which the driving voltage waveforms are applied to the plurality of control electrodes;

FIG. 13C is a drawing explaining another line inversion control of Embodiment 2 in which the driving voltage waveforms applied to the plurality of control electrodes;

FIG. 14A is a drawing explaining a control of the pulse width and the number of cycles of the driving voltage waveforms applied to the plurality of control electrodes according to Embodiment 3.

FIG. 14B is a drawing explaining another control of the pulse width and the number of cycles of the driving voltage waveforms applied to the plurality of control electrodes according to Embodiment 3; and

FIG. 14C is a drawing explaining another control of the pulse width and the number of cycles of the driving voltage waveforms applied to the plurality of control electrodes according to Embodiment 3.

### DESCRIPTION OF EMBODIMENTS

Hereinafter, the embodiments of the present invention will be described with reference to the drawings.

### Embodiment 1

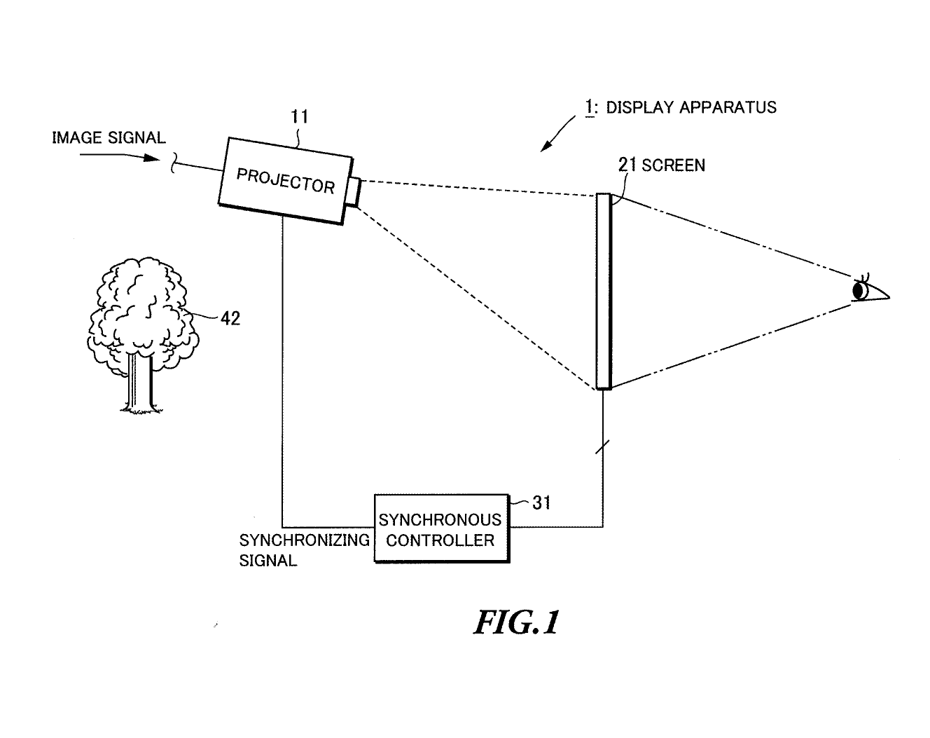

FIG. 1 is a schematic view showing the configuration of a display apparatus 1 according to Embodiment 1. The display apparatus 1 in FIG. 1 includes a projector 11 projecting an image light, a screen 21 that can be controlled its optical states, and a synchronous controller 31. The synchronous controller 31 is connected to the projector 11 and the screen 21. The display apparatus 1 according to the present embodiment is a transmitting type projection apparatus which can scatter and transmit the image light of the projector 11 on the screen 21. The synchronous controller 31 controls the screen 21 onto which the image is projected, in the scattering and transmitting state when the image light is projected, and in the transparent and transmitting state where the scattering of the image is small when the image light is not projected. In the optical states of the screen 21, the scattering and transmitting state is the visual state, and the transparent and transmitting state is the nonvisual state in which the scattering of the incident light is in a lower degree and the transmittance of parallel rays is in a higher degree. The display apparatus 1 can be used as a signboard for displaying advertisements and so on, for example.

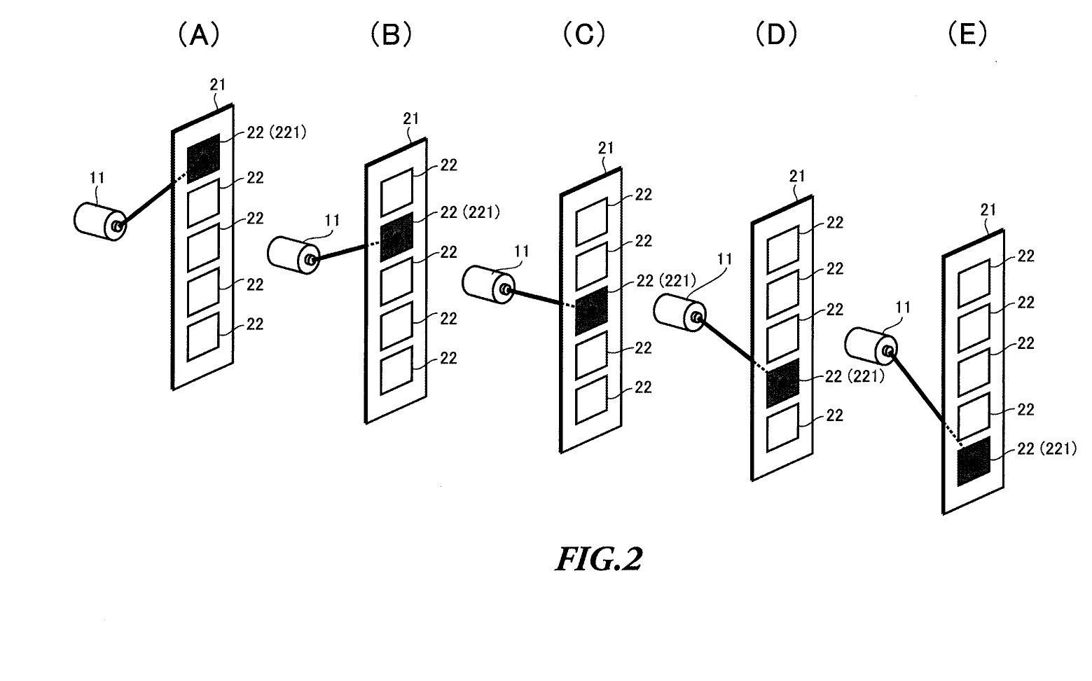

Next, the basic operation principle of the display apparatus 1 in FIG. 1 will be explained. FIG. 2 is a drawing explaining a synchronous control between the scanning and the driving of the screen 21. The projector 11 scans the screen 21 with the image light modulated with image information, in the vertical direction, i.e., from the top to the bottom of the screen 21. The projector 11 scans the screen 21 in the vertical direction repeatedly in every scanning period. FIGS. 2(A) to 2(E) show the scanning states at respective timings in one scanning period, in the scan order. The screen 21 in FIG. 2 has five segmented regions 22. These five segmented regions 22 arranged in the vertical direction along with the scanning direction of the image light. The synchronous controller 31 controls each of optical states of the five segmented regions 22 individually, in synchronism with the one-dimensional scanning in the vertical direction of the screen 21 by the projector 11. When the image light is not projected, each of the segmented regions 22 is controlled in the nonvisual state, that is, in the transparent and transmitting state in which the scattering of the incident light is in low degree.

When the scanning of the image light begins, the scanning light from the projector 11 is firstly is emitted to the top segmented region 22 in the screen 21 as shown in FIG. 2(A). Hereinafter, a reference number 221 will be used for the irradiated segmented region 22 with the scanning light, in order to distinguish it from the other unirradiated segmented regions 22 which are not being scanned. The synchronous controller 31 specifies the period of the top segmented region 221 to be scanned, based on a synchronizing signal from the projector 11, and controls the top segmented region 221 in the visual state. The synchronous controller 31 specifies the part of the scanning period for which the top segmented region 221 is scanned based on a synchronizing signal from the projector 11, and controls the top segmented region 221 to be placed in the visual state. The image light scanning the top segmented region 221 is scattered by the segmented region 221 in the scattering state, and is transmitted as to pass through the screen 21. Next, as shown in FIG. 2(B), the scanning of the image light progresses to the second segmented region 221 from the top of the screen 21. The synchronous controller 31 specifies the period of the second top segmented region 221 to be scanned in the scanning period, and controls the second top segmented region 221 in the visual state. The image light scanning the second top segmented region 221 is scattered by the segmented region 221 in the scattering state, and is transmitted as to pass through the screen 21. After controlling the second top segmented region 221 in the visual state, the synchronous controller 31 controls the top segmented region 22 in the nonvisual state. After that, as shown in FIGS. 2(C) to 2(E), the synchronous controller 31 controls the scanned segmented region 221 with the scanning light in the visual state while controlling the rest segmented regions 22 in the nonvisual state.

By the above described synchronous control, the irradiated region with the scanning light in the screen 21 is maintained in the visual state. By this means, the scanning image light of the screen 21 passes through the screen 21 in the scattering state. Meanwhile, the unirradiated region with the scanning light in the screen 21 is controlled in the nonvisual state. Within the scanning period, each of the segmented regions 22 is mostly controlled in the transparent and transmitting state as the nonvisual state, where the segmented region 22 is not scanned with the scanning light. In the projection period of the image light, a see-through capability of the screen 21 is provided as keeping the image visibility.

The projector 11 may project a modulated image light with image information to the screen 21. Here, the image information is obtained from an inputted image signal to the projector 11. The image signal may be an analog image signal such as in NTSC (National Television Standards Committee) format or in PAL (Phase Alternation by Line) format, or may be a digital image signal such as in MPEG-TS (Moving Picture Experts Group-Transport Stream) format or in HDV (High-Definition Video) format, for example. The projector 11 may not only receive the image signal of a movie, but also receive the image signal of a still image such as in JPEG (Joint Photographic Experts Group) format. In this case, the projector 11 may repeatedly scan the screen 21 with the same image lights of the still image for displaying.

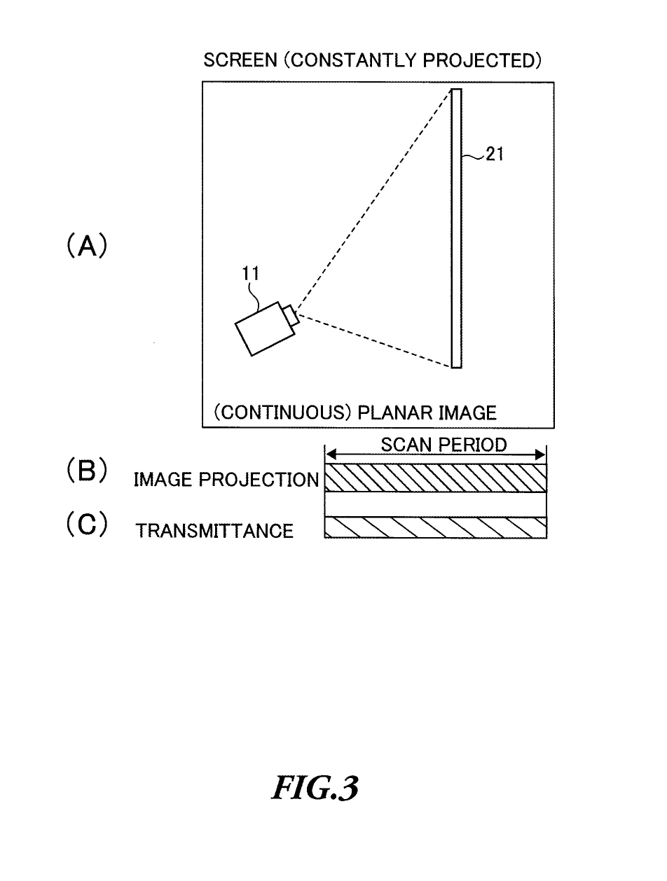

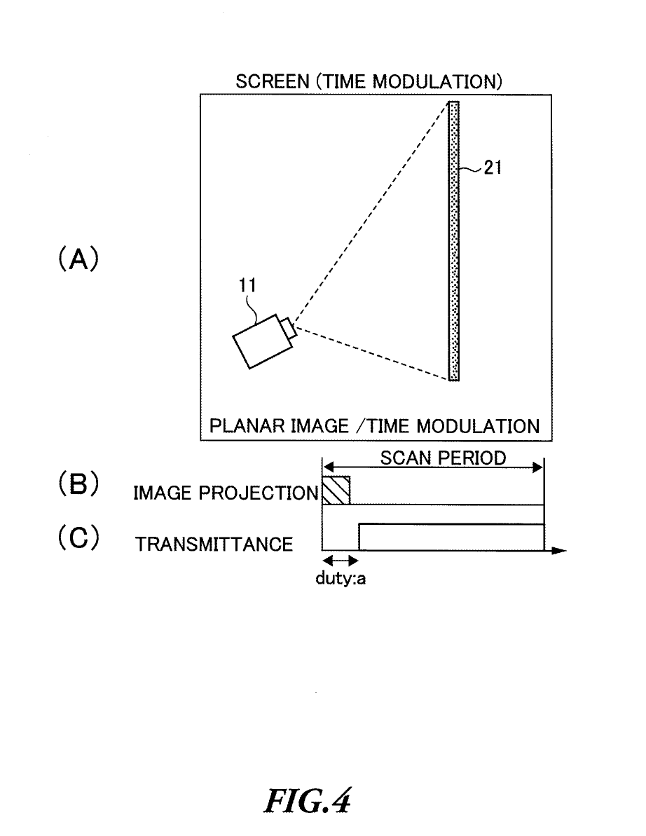

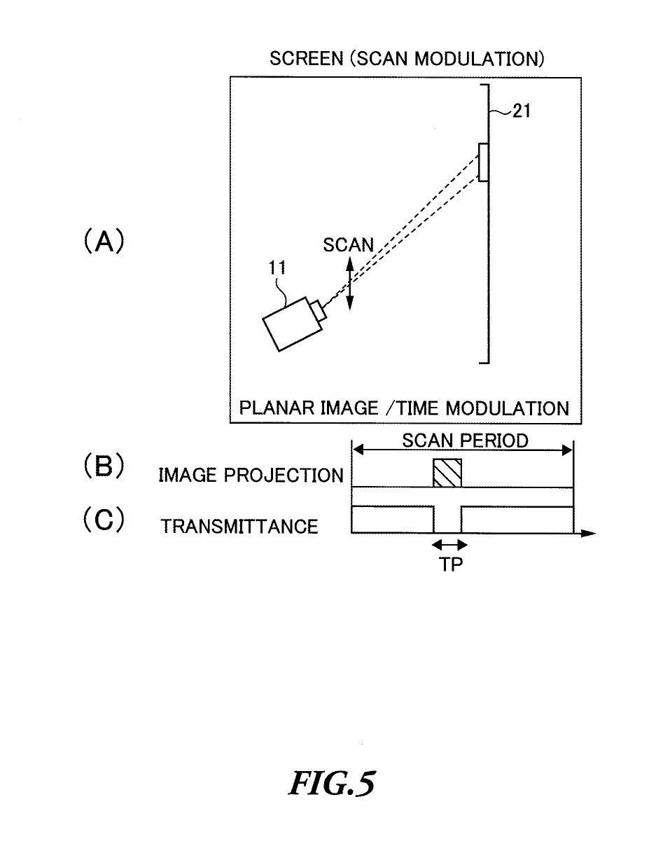

FIGS. 3 to 5 are drawings explaining projecting methods of the projector 11. FIG. 3 is a drawing explaining a projector 11 which continuously projects a plane image. FIG. 4 is a drawing explaining another projector 11 which projects a plane image in a time modulated way. FIG. 5 is a drawing explaining another projector 11 which scans the screen 21.

FIG. 3(A) shows a projecting method in which the projector 11 projects image light constantly. In this case, as shown in FIG. 3(B), the image light is continuously projected onto the screen 21 during the scanning period. The screen 21, as shown in FIG. 3(C), is required to be kept in the scattering state continuously. In this case, when the optical state of the screen 21 is controlled to increase the transmittance of parallel rays, the luminance of the visible image is reduced. Here, in FIGS. 3(B) and 3(C), the horizontal axes represent the scanning period (time). The same definitions are applied to FIGS. 4(B) and 4(C) and FIGS. 5(B) and 5(C).

FIG. 4(A) shows another projecting method in which the projector 11 projects image light at some interval. In this case, as shown in FIG. 4(B), the image light is projected onto the screen 21 in a short part time within the scanning period. The screen 21, as shown in FIG. 4(C), may be kept in the scattering state only at a part of the scanning period. Then, during the period other than that part, the optical state of the screen 21 can be controlled to increase the transmittance of parallel rays of the screen 21, and it is possible to achieve the see-through capability of the screen 21 during the scanning period without decreasing the luminance of the visible image. However, in order to obtain the same luminance as in the case of the above constant projection of the image light, as shown “duty: a” in FIG. 4(C), it is required to a higher intensity of the projection light at an about approximately inverse number of the duty which is calculated by dividing the scattering state time with one scan period. Therefore, to achieve a high see-through capability, a powerful pulse projection light is required.

FIG. 5(A) shows another projecting method in which the projector 11 scans the screen 21. In this case, the image light is constantly projected onto the screen 21 during the whole scan period. However, as shown in FIG. 5(B), as for each partial region of the screen 21 being paid attention, the image light is projected in a part time during the scanning period. Therefore, as shown in FIG. 5(C), each partial region of the screen 21 is required to be kept in the scattering state during the partial scanning period TP when each partial region is scanned. In addition, each partial region of the screen 21 can be controlled to increase the transmittance of parallel rays during the period other than the partial scanning period TP, and it is possible to achieve the see-through capability of the screen 21 during the scanning period without decreasing the luminance of the visible image.

The projector 11 that projects image light may adopt any one of above described projecting methods. However, in order to reduce unused image light for scattering, the method in FIG. 4 or FIG. 5 is preferred. In addition, a response time is required and needed to change the optical state of the screen 21. Therefore, the projecting method in FIG. 5 is preferred over the method in FIG. 4, because the former method can easily provide the response time than the latter method. Hereinafter, a case in which the projector 11 adopts the method in FIG. 5 will be explained.

With the driving method in FIG. 5, in a scanning period of the image light, linear shaped divided images corresponding to partial regions of the screen 21 are projected on the displaying surface of the screen 21 sequentially. For the projector 11, a transmitting type liquid crystal light bulb or a reflecting type liquid crystal light bulb may be used, which sequentially shifts a black stated area (where the light is not projected) on the screen 21 in the scanning period. Further, other elements than these bulbs may be used. In addition, the projector 11 may perform a raster scan in the scanning period of an image, and may project dotted light images sequentially on the displaying surface of the screen 21. For this projector 11, a laser projector may be used, in which a modulated light beam with an image is reflected by a rotating mirror as to shift the illuminating direction of the beam. This projector 11 may be considered as one kind of a sequential scanning projector, which scans with a lighting spot in one direction of screen 11.

The screen 21 may be changed its optical state by the inputted voltages or currents of electrical signals. For example, a modulation screen and so on may be used as one, the modulation screen being provided with a liquid crystal material and being switched between the scattering state and the transparent and transmitting state where the scattering of the incident light is in low degree. The modulation screen may use liquid crystal elements such as polymer-dispersed liquid crystal (PDLC) and so on, or may use elements to move white powder in transparent cells and so on, to be switched between the scattering state and the transparent and transmitting state where the scattering of the incident light is in low degree. With the present embodiment, the screen 21 operating in the reverse mode will be explained as an example. The screen 21 operated in the reverse mode is in the transparent and transmitting state, when in the normal state where no voltage is applied. When being applied a voltage, the screen 21 is in the scattering state, in which the transmittance rate or the scattering rate of parallel rays is in accordance with the applied voltage.

Moreover, the screen 21 may have a plurality of dividing segmented regions 22 of the screen 21, and each of the regions may be switchable at each of respective timings between the scattering state and the transparent and transmitting state where the scattering of the incident light is in lower degree. For example, the screen 21 may have a plurality of strip shaped segmented regions which are corresponding and divided in the main scanning direction (or in the vertical direction of FIG. 2, for example) of the projector 11. In addition to this, the screen 21 may have a plurality of square shaped segmented regions which are corresponding and divided in the scanning direction and in the sub scanning direction (or in the horizontal direction of the image, for example) of the projector 11.

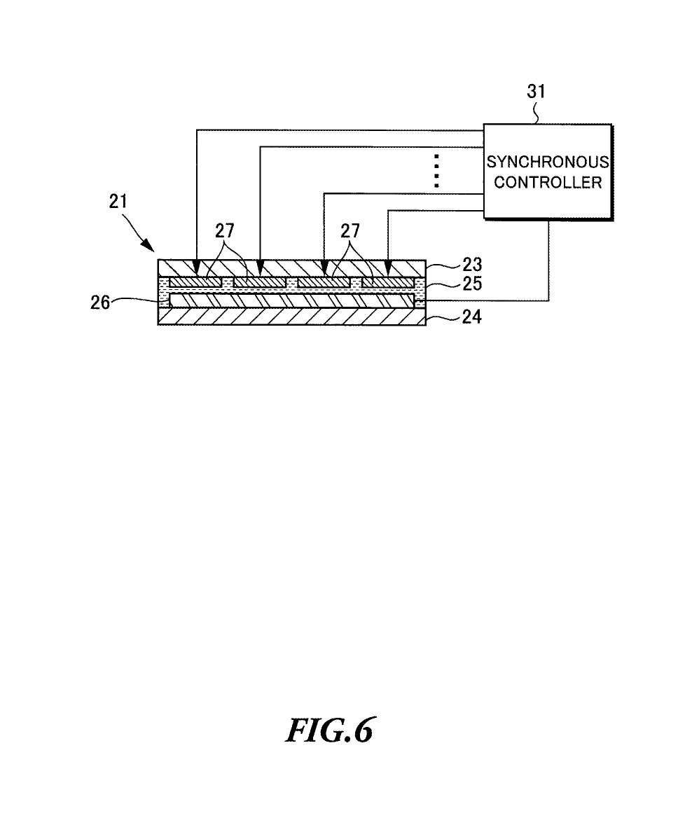

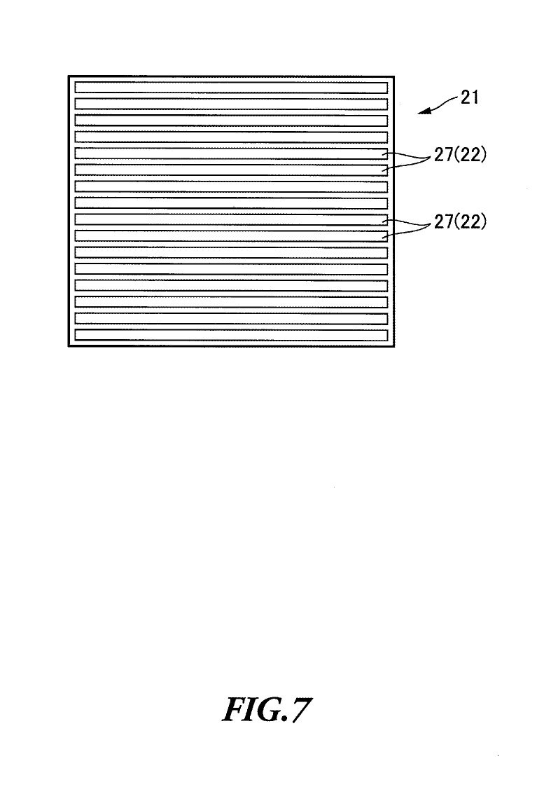

FIG. 6 is a schematic cross-sectional view of a screen 21 whose optical state can be controlled by each of segmented regions 22. FIG. 6 also shows the synchronous controller 31. FIG. 7 is a schematic front view of the screen 21 to show the array of a plurality of control electrodes. The exemplary screen 21 in FIG. 6 has an optical layer 25 in which composite material including liquid crystal is sandwiched between a pair of transparent glass plates 23 and 24. On one surface of the glass plate 24 on the side of the optical layer 25, a counter electrode 26 is formed entirely. On one surface of the glass plate 23 on the side of the optical layer 25, a plurality of control electrodes 27 are arranged. Intermediate layers of insulating materials may be formed between the optical layer 25 and the electrodes 26 and 27. The counter electrode 26 and the control electrodes 27 are formed as transparent electrodes from ITO (indium tin oxide). The optical layer 25 is disposed between the plurality of control electrodes 27 and the counter electrode 26.

The plurality of control electrodes 27 are located in the irradiated region of the screen 21 with the image light, and divide by strip shaped regions which are arranged in one direction or in the scanning direction, for example. The plurality of control electrodes 27 are individually connected to the synchronous controller 31, and are applied individual voltages. The control electrodes 27 next to each other are arranged with a space therebetween. In the optical layer 25, a gap region is formed at the corresponding region between the control electrodes 27 next to each other, at the position where the control electrode 27 is not formed. In FIG. 6, the counter electrode 26 is connected to the ground. A voltage is applied to the control electrodes 27 as to generate a potential difference with the counter electrode 26. Here, the voltage of a drive waveform described later indicates the potential difference between the control electrodes 27 and the counter electrode 26. The voltage applied to the control electrodes 27 is applied to the optical layer 25 in the corresponding region to the control electrodes 27. In the optical layer 25, the orientation of the liquid crystal molecules is changed by the applied voltage to the control electrodes 27. The optical layer 25 can be controlled by the unit of the segmented region 22, and can be controlled between the transparent and transmitting state in which the scattering degree of the incident light is low and the scattering state in which the incident light is scattered. Here, the gap region 28 is formed in the width about 5 to 100 micrometers, and may be formed as narrow width as possible. The thickness of the optical layer 25 is several or several dozen of micrometers, and is determined with the optical capability and the driving voltage being accounted.

The synchronous controller 31 is connected to the projector 11 and the screen 21. The synchronous controller 31 controls the optical state of the screen 21, in synchronous with the projection of the image light from the projector 11. As the synchronizing signal from projector 11 and inputted to the synchronous controller 31, a synchronizing signal can be used, which is synchronous with the scanning period of the projector 11, for example.

As shown in FIG. 7, when the screen 21 is divided into strips in one direction, the projection light of the projector 11 scans them sequentially in the divided direction of the screen 21. Based on the synchronizing signal from the projector 11, the synchronous controller 31 switches the plurality of segmented regions 22 in the scanning order from the transparent and transmitting state to the scattering state, as for the irradiated region of the projection light from the projector 11 to be kept and maintained in the visual state (or in the scattering state as for the present embodiment). By this synchronous control, each of the segmented regions 22 of the screen 21 is placed in the scattering state as the visual state, in the irradiated period Ton which includes the visualizing period and in which each of the segmented regions 22 is irradiated with the projected light. Meanwhile, each of the segmented regions 22 is placed in the transparent and transmitting state as a nonvisual state, in the no visualizing period Toff in which each of the segmented regions 22 is not irradiated with the projected light. The screen 21 can have the transparency as for the back side object to be recognized visually, and also can scatter and transmit the image light in the same brightness when the screen 21 is continuously controlled in the scattering state. That is, it is possible to achieve both of a see-through capability enough for the back side object to be recognized visually and a high visibility of the image.

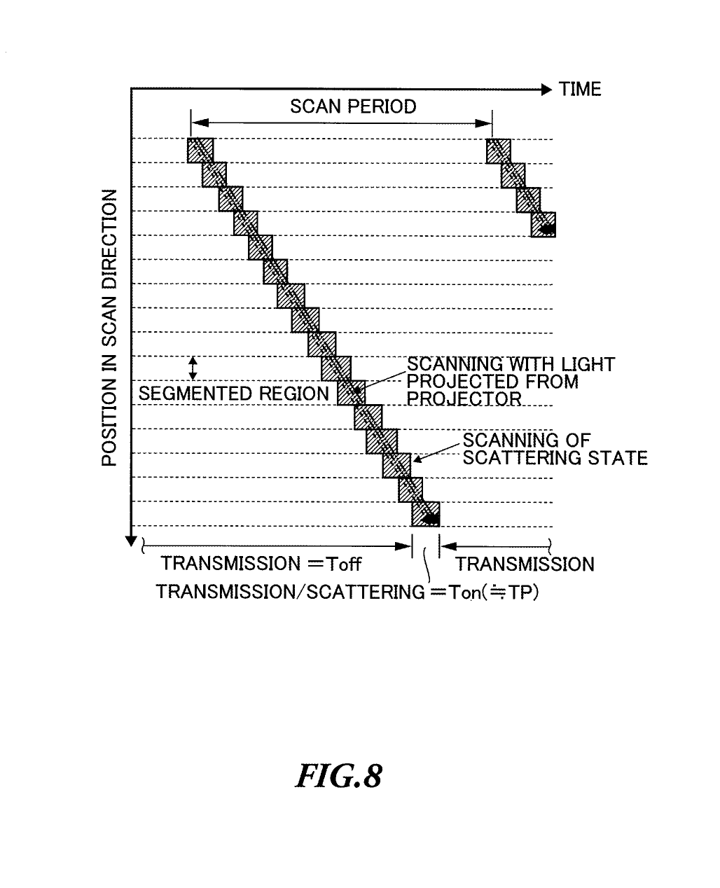

FIG. 8 is a schematic timing chart showing the scanning and the driving of the screen 21. The horizontal axis represents time. The vertical axis represents the vertical positions in the vertical direction of the screen 21, and is correspond to the plurality of segmented regions 22 of the screen 21. Before the timing at which each of the segmented regions 22 is started to be scanned with the image light, each of the segmented regions 22 of the screen 21 is controlled and switched to be in the scattering state from the transparent and transmitting state. In addition, after the timing at which each of the segmented regions 22 is finished to be scanned, each of the segmented regions 22 in the scattering state is controlled and switched to the transparent and transmitting state from the scattering state. Each of the plurality of segmented regions 22 is controlled to be placed in the visual state in the partial scanning period TP as synchronous with the irradiation of the scanning image light to the segmented region 22, and therefore can be switched in the visual state sequentially in the scanning order with a shifted time therebetween. The scanning image light of the screen 21 is scattered efficiently by the regions sequentially kept in the visual state, and therefore it is possible to provide high brightness and visibility.

The switch timing information for this synchronous control is transmitted from the projector 11 to the synchronous controller 31, as a synchronizing signal. Preferably, the synchronous controller 31 controls the applying voltages to each of the control electrodes 27, as for the projection light to be irradiated within the period where each of the stabled segmented regions 22 is stabilized in a predetermined scattering state. The optical state of each of the segmented regions 22 is switched, in accordance with the signal waveform of the applied voltage to the control electrodes 27. Particularly, the outputted switch timing information from the projector 11 to the synchronous controller 31 may include both of information of scanning start timings of each of the scanning period by the projector 11 and information of the scanning speed (or the scanning delay/shift time). With the information, even if the frequency of the scanning period is changed, it is possible to follow and to achieve a satisfactory see-through display without distorting the image. Here, the projector 11 and the synchronous controller 31 may be formed with wireless communicators which use electromagnetic waves such as micro waves or infrared rays, and the synchronizing information may be transmitted and received by the wireless signal.

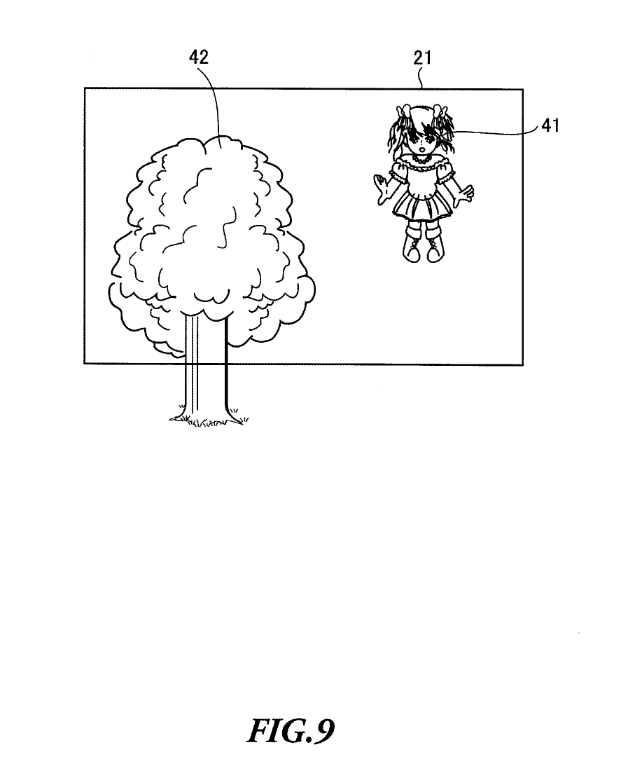

By the above-described synchronous control, the synchronous controller 31 according to the present embodiment can switch the optical states of the plurality of segmented regions 22 in the scanning period T for scanning with the image light, in synchronous with the scanning of the image light by the projector 11, and controls the optical state of the regions in the visual state where the image light is projected thereon. Therefore, the screen 21 can display the image by the periods Ton including the timings at which the segmented regions 22 are irradiated with the image light, because each of the regions in the screen 21 is kept and maintained in the scattering state when the image light is irradiated thereon. In addition, during the period of time other than the period Ton, each region in the screen 21 is controlled to be in the transparent and transmitting state, and thus it is possible to see through the screen 21 in the projected period of image light. The light passing through the screen 21 can be seen as being averaged (or integrated) with the human eyes, and therefore it is possible to achieve a see-through capability without a flicker, if the scanning period is reasonably short. By this means, under the configuration in FIG. 1, it is possible to visually recognize the image in FIG. 9 on the screen 21. FIG. 9 is a drawing explaining an overlaid displaying state of an image formed by image light and a back side image of the screen 21. In FIG. 9, the image of a person 41 formed by the image light can be seen in the right side of the screen 21, while a back side image of a tree 42 which is located as the back side of the screen 21 can be seen in the left side thereof.

In addition, with the present embodiment, the synchronous controller 31 switches the applying voltages to the plurality of segmented region 22 in the scan order in the scanning period of the image light, so as for each of the segmented regions 22 to be placed in the visual state during the partial scanning period TP in which each of the segmented regions 22 is scanned, and so as for each of the segmented regions 22 to be placed in the nonvisual state during the period other than the partial scanning period TP in which each of the segmented regions 22 is not scanned.

Moreover, with the present embodiment, the synchronous controller 31 uses an alternative voltage with a low frequency as the applying voltage to each of the control electrodes 27. Therefore, in each of the scanning period T of the image light, it is possible to reduce the DC component in the applying voltage to the optical layer 25.

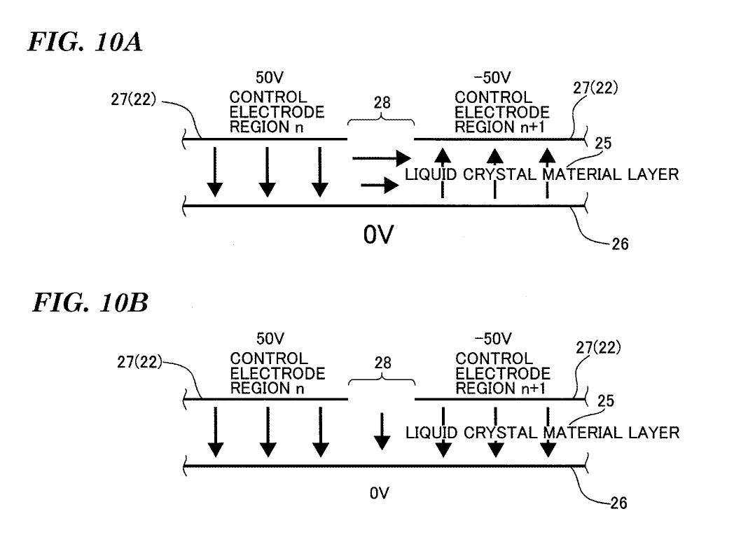

Here, in a case in which the plurality of control electrodes 27 are formed on one surface of the screen 21 in the reverse mode and the driving voltages are applied individually thereto, as shown in FIG. 6 and FIG. 7, gap areas 28 are needed to be formed in the optical layer 25 between the segmented region 22 next to each other, at the corresponding regions where the control electrode 27 are not formed. FIGS. 10(A) and 10(B) are drawings explaining electric field distributions in the optical layer 25 for the gap region 28. To be more specific, each of FIGS. 10(A) and 10(B) is a schematic cross-sectional view showing the screen 21 in the state in which the voltages are applied to the control electrodes 27 next to each other. The arrows in the figures show rough electric field distributions.

As shown in FIG. 10(A), even though alternative voltages with the same amplitude are applied to the respective control electrodes 27, when a positive voltage is applied to the right control electrode 27, a negative voltage is applied to the left control electrode 27, and the voltage of 0V is applied to a counter electrode 26, that is, when the voltages with the reverse polarity are applied to the control electrodes 27 next to one another, an electric field is formed in the gap region 28, which differs in orientation from the electric fields in the segmented regions 22 corresponding to the control electrodes 27. The orientation of the liquid crystal in the optical layer 25 is influenced by these electric fields. Therefore, the optical state of the gap region 28 is different from the optical state where the voltages are directly applied. The difference of the electric fields and the difference of the orientations of the liquid crystal causes the optical capability difference at the gap regions 28, and the difference is visually recognized as strip shaped uneven luminance at the timing in which the image light is irradiated,

In the optical state of the screen 21 of FIG. 10(A), both of the optical states of the segmented region 22 are equalized, but the optical states of the gap region 28 are different therefrom. As a result, a peculiar optical state is occurred along with the gap region 28, and therefore the uneven luminance emerges in the visual state.

Therefore, with the present embodiment, as shown in FIG. 10(B), the synchronous controller 31 applies the same polarity voltages to the control electrodes 27 next to one another. In the case shown in FIG. 10(B), the orientation of the electric fields of the gap region 28 is along with the orientation of the electric fields in the segmented regions 22, and therefore the optical state of the gap region 28 is controlled almost the same with the optical state of the segmented regions 22, so as to be in the scattering state as if the voltage is applied. As a result, in the screen 21 of FIG. 10(B), the optical state of the gap region 28 is approximately the same as that of both sides of the segmented regions 22, uneven luminance at the gap region 28 in the image is reduced effectively when the image light is projected on the gap region 28, and therefore it is possible to display the image in a constant way as realizing a see-through capability. When the control electrodes 27 next to one another are in the same potential or in the same polarity, the orientation of the electric field in the gap region 28 is along with those of the segmented regions 22, and it is possible to reduce the striped degradation, which is caused by the orientation differences therebetween.

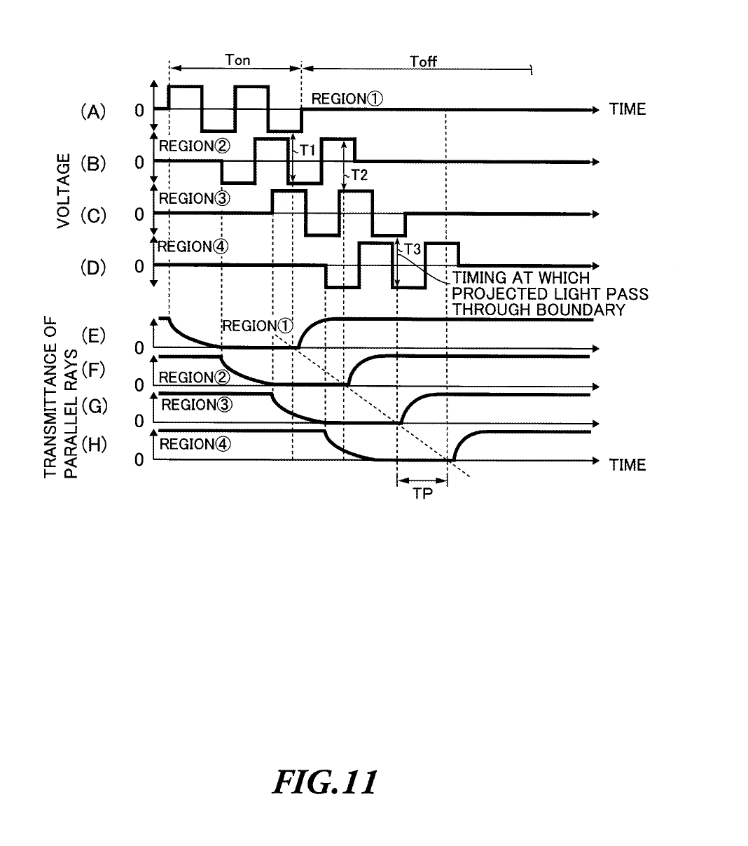

FIG. 11 is a schematic timing chart showing the relationship between the optical states of the plurality of segmented regions 22 and the driving voltage waveforms in the present embodiment. FIGS. 11(A) to 11(D) show the applying voltages to four consecutive control electrodes 27. Hereinafter, although the waveforms are described as the voltages which are applied to the control electrodes 27, the waveforms can be thought as the voltage differences with the counter electrode 26, which are applied to the regions including the optical layer 25. The horizontal axis represents the time, and the vertical axis represents the driving voltage. FIGS. 11(E) to 11(H) show the optical capability of those four consecutive segmented regions 22, which are corresponding to FIGS. 11(A) to 11(D) respectively. The horizontal axis represents the time, and the vertical axis represents the transmittance of parallel rays. Hereinafter, a change of the optical state will be explained by the change of the transmittance of parallel rays. With the screen 21 according to the present invention, a decrease of the transmittance of parallel rays means an increase of the scattering. As shown in FIGS. 11(A) to 11(D), in consecutive four the no visualizing period Toff in which each of the segmented regions 22 are not scanned, the application of the voltage to the control electrodes 27 is stopped, to control the segmented regions 22 to be placed in the transparent and transmitting state. Then, the application of the voltage begins before the partial scanning period TP for which each of the segmented regions 22 is scanned. The applied voltage is an alternative voltage. By the application of this voltage waveform, as shown in FIGS. 11(E) to 11(H), the four consecutive segmented regions 22 are controlled to be switched to the scattering state from the transparent and transmitting state. In addition, as shown in FIGS. 11(A) to 11(D), after each of the segmented regions 22 has been scanned, the application of the voltages to the four consecutive control voltages 27 is stopped, in order to control each of the segmented regions 22 to be placed in the transparent and transmitting state. By the application of this voltage waveform, as shown in FIGS. 11(E) to 11(H), the four consecutive segmented regions 22 are controlled to be switched from the scattering state to the transparent and transmitting state. Here, the reference timing information for the synchronous control is transmitted from the projector 11 to the synchronous controller 31. In order to irradiate each of the segmented regions 22 with the projected light within the equalized and stabilized period in a scattering properties, the synchronous controller 31 sequentially change the applying voltages to the plurality of control electrodes 27, based on the reference timing.

At timing T1 shown in FIGS. 11(A) to 11(D), the scanning image light moves from the segmented region 22 in FIG. 11(A) to the segmented region 22 in FIG. 11(B). At this timing T1, the scanning image light crosses the gap region 28 between the two segmented regions 22. Then, at this timing T1, the control electrode 27 in FIG. 11(A) and the control electrode 27 in FIG. 11(B) are applied voltages which are in the same polarity and in the same potential. Therefore, the optical state of the gap region 28 is controlled to be placed in the visual state shown in FIG. 10(B). The gap region 28 is placed in the same optical state as of the segmented regions 22, and scatters and transmits the image light as well. Likewise, at timing T2 in FIGS. 11(A) to 11(D), the control electrode 27 in FIG. 11(B) and the control electrode 27 in FIG. 11(C) are applied voltages which are in the same polarity and in the same potential. Likewise, at timing T3 in FIGS. 11(A) to 11(D), the control electrode 27 in FIG. 11(C) and the control electrode 27 in FIG. 11(D) are applied voltages which are in the same polarity and in the same potential. Likewise, at timing T3 as shown in FIGS. 11(A) to 11(D), the voltages with the same polarity and the same potential are applied to the control electrode 27 of FIG. 11(C) and the control electrode 27 of FIG. 11(D). As a result, the image light is scattered and transmitted by the gap region 28, which is almost in the same scattering state of the segmented regions 22.

As described above, with the present embodiment, the synchronous controller 31 applies the voltages with the same polarity to the two control electrodes 27 next to one another, at the timing at which the gap region 28 between those two control electrodes 27 is scanned with the image light. By this means, it is possible to control the optical state of the gap region 28 to be placed in a desirable optical state, which is located at the corresponding region between the two segmented regions 22 and in which control electrode 27 is not formed. Particularly, the projector 11 scans the screen 21 with the image light, and the screen 21 operates in the reverse mode in which the transmittance of parallel rays is lowered when a voltage is applied, and the irradiated image light is scattered. Therefore, in the screen 21 in the reverse mode, it is possible to control the optical state of the gap region 28 between two segmented regions 22 in the visual state. In addition, when the image light moves from one segmented region 22 to the next segmented region 22, the synchronous controller 31 applies the voltages with the same polarity and the same amplitude to the two control electrodes 27 which is corresponding to those two segmented regions 22. Therefore, it is possible to control the optical state of the gap areas 28 in the screen 21 in the reverse mode, to be placed in the same visual state as in the segmented regions 22. By this means, it is possible to reduce the influence of the uneven luminance by the gap region 28, in the image formed by the scattering of the screen 21. The degradation of the displayed image is not likely to occur in the displayed image in the entire screen 21.

### Comparative Example 1

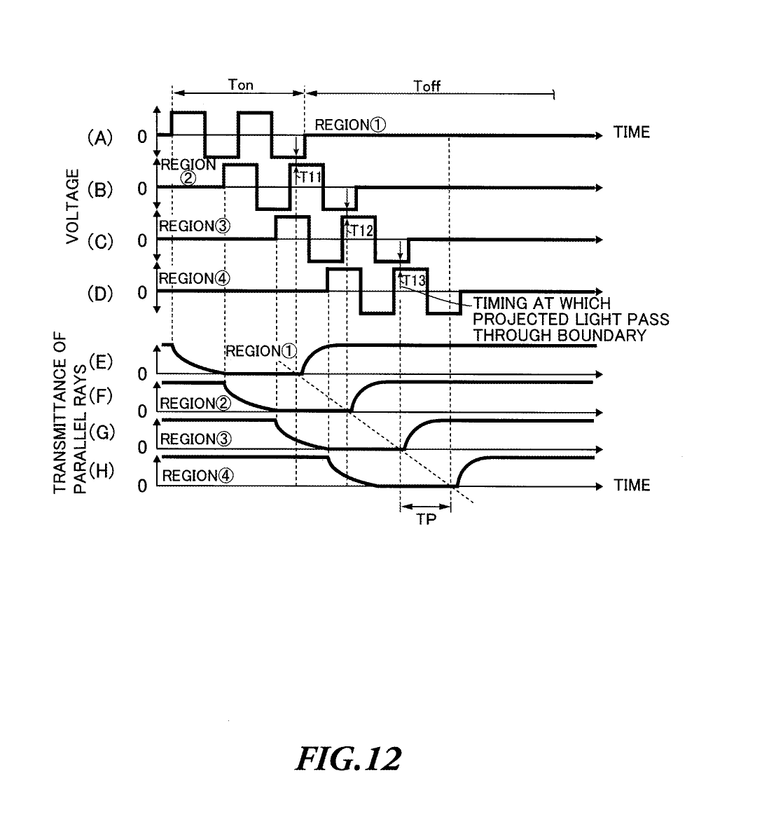

The display apparatus 1 with Comparative example 1 is the same as the display apparatus 1 with Embodiment 1. However, the synchronous controller 31 applies driving voltages to the plurality of control electrodes 27 without respect to the control of the gap areas 28. FIG. 12 is a schematic timing chart showing the relationship between the optical states of the plurality of segmented regions 22 and the driving voltage waveforms according to Comparative example 1. FIGS. 12(A) to 12(H) are corresponding to FIGS. 11(A) to 11(H), respectively. In Comparative example 1, when the gap region 28 is scanned with the image light at timings T11, T12 and T13 shown in FIGS. 12(A) to 12(D), the voltages with the reverse polarity and the same amplitude are applied to the control electrodes 27 in the both sides of the gap region 28. Therefore, the optical state of the gap region 28 is controlled to be placed in the visual state shown in FIG. 10(A). The gap region 28 is placed in the different optical state from the segmented regions 22, and scatters the image light differently. As a result, the scattering capability of the gap region 28 is different from the scattering capability of the segmented regions 22, and therefore the displaying image degradation occurs in the entire screen 21.

### Comparative Example 2

With Comparative example 2, a modification of the display apparatus 1 according to Embodiment 1 will be explained. The periods of time, in which the projected image light from the projector 11 scans one segmented region 22, are approximately the same among the plurality of segmented regions 22. Hereinafter, this period of time will be referred to as “scan delay time Td”. The scan delay time Td is decreased when the projector 11 is located at a long distant from the screen 21 (and thus the effective division by the image region is increased in the number), and the scan delay time Td is increased when the projector 11 is located at a short distant from the screen 21 (and thus the effective division by the image region is decreased in the number), for example. Further, the scanning by the projectors 11 is different and unique to each projector 11. Particularly, in the last partial scanning for the last segmented region 22 in the scanning period, the difference is usually big between the projectors.

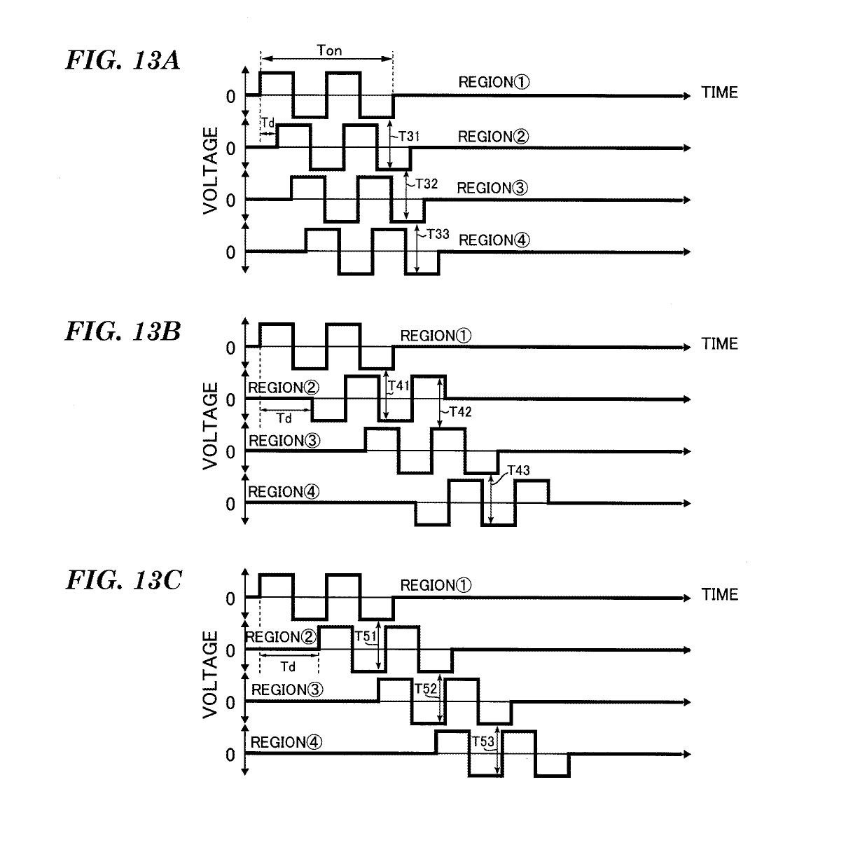

With Embodiment 2, to corresponding to the variable scan delay time Td, the synchronous controller 31 adjusts the driving voltage waveform, so as to equalize the polarities of the control electrodes 27 at the timing when the gap region 28 therebetween is scanned. To be more specific, the synchronous controller 31 determines whether or not the inversion of the driving voltage waveforms is required for every control electrode 27, based on both of the scan delay time Td obtained from the scanning period of the image light, and the frequency of the alternative voltages applied to the plurality of control electrodes 27, for example. Then, at the timing when the gap region 28 is scanned, the synchronous controller 31 appropriately executes line inversions of the driving voltage waveforms, so as to equalize the polarities of the voltages of the control electrodes 27 which is located at the both sides of the scanning gap region 28. FIGS. 13(A) to 13(C) are drawings explaining the line inversion control of the driving voltage waveforms applied to the plurality of control electrodes 27 with Embodiment 2. The three driving voltage waveforms shown in FIGS. 13(A) to 13(C) are the driving voltage waveforms with a constant frequency. The horizontal axis represents the time, and the vertical axis represents the voltage.

As shown in FIG. 13(A), when the scan delay time Td is small, all of the scanning timings T31, T32, and T33 of the gap regions 28 with the image light are fit within the half cycle of the driving voltage waveform. In this case, the synchronous controller 31 determines that the inversion control is not required, in each of the inversion judgments of each of the driving voltage waveforms. As a result, as shown in FIG. 13(A), when these four voltage waveforms are applied to the control electrodes 27, the voltages are determined to change in the same polarity, and are applied to each of the control electrodes 27 in the polarity. Here, to get the scan delay period Td, the synchronous controller 31 may calculate an actual scanning period for scanning the plurality of the segmented regions based on the informed scanning period of the image light by the projector 11, and then calculate a value, which is obtained by dividing the actual scanning period for scanning the plurality of the segmented regions by the number of the control electrodes 27.

As shown in FIG. 13B, in a case in which the scan delay period Td is lengthened a little, at least a part of the scanning timings T41, T42, and T43 of the gap region 28 with the image light does not fit within the half cycle of the driving voltage waveform. In this case, the synchronous controller 31 determines that the inversion control is needed appropriately, in the inversion judgments of each of the driving voltage waveforms. As a result, as shown in FIG. 13(B), the second row driving voltage waveform from the top is inverted to the first one, the third row driving voltage waveform from the top is inverted to the second one, and the fourth row driving voltage waveform from the top is inverted to the third one.

As shown in FIG. 13(C), in a case in which the scan delay time Td is further lengthened, the time distances between each of the scanning timings T51, T52, and, T53 of the gap region 28 with the image light are getting further longer. In this case, the synchronous controller 31 determines that the inversion control is needed appropriately, in the inversion judgments of each of the driving voltage waveforms. However, as shown in FIG. 13(C), the shown driving voltage waveforms are not inverted to the preceding one as to change in the same polarity, and are applied to each of the control electrodes 27.

As described above, the synchronous controller 31 according to the present embodiment applies the common alternative voltages to the plurality of control electrodes 27 based on a same waveform. In addition, the synchronous controller 31 adjusts the practically applying alternative waveforms to the plurality of control electrodes 27, based on the condition of the scanning period T of the image light and the condition of the frequency of the applying alternative voltages to the plurality of control electrodes 27. To be more specific, the synchronous controller 31 adjusts and inverses at least a part of the alternative voltage waveforms to the other alternative voltage waveforms, as for the applying voltages to the both side segmented regions 22 of a gap region 28 to be in the same polarities, at the scanning timing of the gap region 28 with the image light. That is, with the present embodiment, the synchronous controller 31 executes the line inversion/non-inversion control, to equalize the potentials or the polarities of the both side segmented regions 22 of a gap region 28 at the scanning timing of the gap region 28 with the image light, based on the scanning delay time of the region to be projected by the projector 11 and (the pulse width of) the common driving voltage waveform. Here, when the common driving voltage waveform includes the half cycled voltage, the synchronous controller 31 may inverts the applying driving voltage waveform by the unit of the scanning period. As the result, with the present embodiment, even if the scanning period T of the screen 21 by the projector 11 is changed, it is possible to control the plurality of gap areas 28 of the screen 21 in the same scattering state (visual state) with the segmented regions 22, in synchronous with the change.

### Embodiment 3

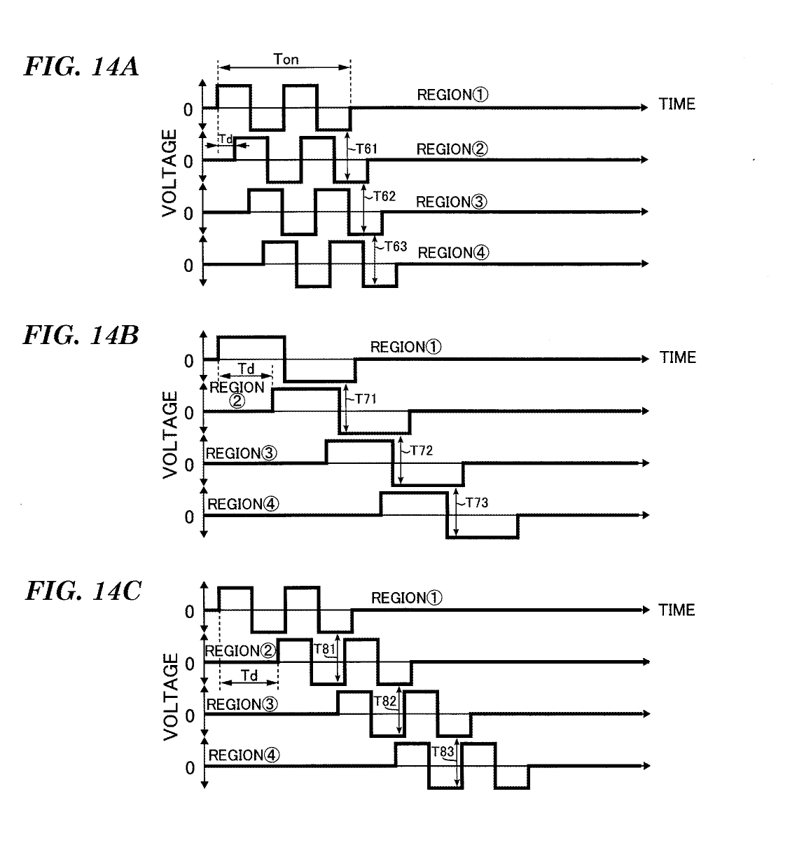

With Embodiment 3, a modification of the display apparatus 1 according to Embodiment 2 will be explained. The synchronous controller 31 according to Embodiment 3 controls the common driving voltage waveform by the pulse width and the number of cycles thereof, instead of controlling the common driving voltage waveform with the line inversion. FIGS. 14(A) to (C) are drawings explaining the controlled pulse widths and the controlled number of cycles of the driving voltage waveforms applied to the plurality of control electrodes 27. In each of FIGS. 14(A) to 14(C), the pulse widths and the number of cycles of the driving voltage waveforms are controlled, as for the both voltages which are applied to the both side segmented region 22 of the gap region 28 to be in the same polarity, at the scanning timing of the gap regions 28 with the image light. The horizontal axis represents the time, and the vertical axis represents the voltage.

As shown in FIG. 14(A), when the scan delay time Td is small, the scanning timings T61, T62, and T63 at which the gap region 28 is scanned with the image light are fit within the half cycle of the common driving voltage waveform. In this case, the synchronous controller 31 determines that it is not necessary to adjust each of the driving voltage waveforms, in the judgment process of the driving voltage waveform. As a result, as shown in FIG. 14(A), these four driving voltage waveforms are in their original waveform, and are applied to the each of the control electrodes respectively as to be in the same polarities.

As shown in FIG. 14(B), in a case in which the scan delay time Td is lengthened a little, the scanning timings T71, T72, and T73 at which the gap region 28 is scanned with the image light are not fit within the half cycle of the standard driving voltage waveform. In this case, the synchronous controller 31 determines that it is necessary to adjust the common driving voltage waveforms, in the judgment process of the driving voltage waveform. In this case, as shown in FIG. 14(B), the synchronous controller 31 reduces the number of cycles of the driving voltage waveforms in half, for example. These four driving voltage waveforms that are adjusted in the waveforms with widened pulse widths thereof, and are applied to the each of the control electrodes respectively as to be in the same polarities.

As shown in FIG. 14(C), in a case in which the scan delay time Td is further lengthened, the time distances between the scanning timings T81, T82, and, T83 of the gap regions 28 with the image light are further longer. In this case, the synchronous controller 31 determines that it is not necessary to adjust each of the driving voltage waveforms, in the judgment process of the driving voltage waveform. As a result, as shown in FIG. 14(C), these four driving voltage waveforms are in their original waveform, and are applied to the each of the control electrodes respectively as to be in the same polarities.

As described above, the synchronous controller 31 according to the present embodiment applies the alternating voltages in the same waveform to the plurality of control electrodes 27. In addition, the synchronous controller 31 adjusts the common alternating voltage waveforms to be applied to the plurality of control electrodes 27, based on the conditions of the scanning period T of the image light and of the frequency of the alternating voltages applied to the plurality of control electrodes 27. To be more specific, the synchronous controller 31 adjusts the pulse widths or the number of cycles of the driving voltage waveforms, as for the applying voltages to the both side segmented regions 22 of a gap region 28 to be in the same polarities, at the scanning timing of the gap region 28 with the image light. That is, with the present embodiment, the synchronous controller 31 executes the pulse width control or the cycle number control, to equalize the potentials or the polarities of the both side segmented regions 22 of a gap region 28 at the scanning timing of the gap region 28 with the image light, based on the scanning delay time of the region to be projected by the projector 11 and (the pulse width of) the common driving voltage waveform. Here, when the common driving voltage waveform includes the half cycled voltage, the synchronous controller 31 may inverts the applying driving voltage waveform by the unit of the scanning period. As the result, with the present embodiment, even if the scanning period T of the screen 21 by the projector 11 is changed, it is possible to control the plurality of gap areas 28 of the screen 21 in the same scattering state (or visual state) with the segmented regions 22, in synchronous with the change.

Although the preferred embodiments have been explained, it is by no means limiting, but it will be appreciated that various modifications and alternations are possible within the scope of the invention.

For example, the synchronous controller 31 executes the line inversion control of the common driving voltage waveform in Embodiment 2, and executes the pulse width control in Embodiment 3. In addition to these, the synchronous controller 31 may executes both of the line inversion control and the pulse width control of the common driving voltage waveform, based on the scan delay time Td which is determined by the projector 11 and by the projection region.

With the above described embodiments, the screen 21 is controlled in the scattering state for the visual state, and therefore transmits and scatters the image light. In addition to this, the screen 21 may be controlled in the high scattering state for the visual state, and therefore scatters the image light. In this case, the screen 21 functions as a reflective screen, and the viewer is located in the same side with the projector 11 of the side to be projected of the screen 21.

Moreover, with the above-described embodiments, the screen 21 in use is in the reverse mode. In addition to this, for example, the screen 21 in use may be in the normal mode. In the normal mode of the screen 21, the transmittance of parallel rays is increased by applying a voltage, and the screen 21 can be applied voltages for the scattering state as to be driven in the visual state. For example, in a case in which the screen 21 in the normal mode scatters the irradiated image light, the synchronous controller 31 may control and apply the applying voltages in the same polarities to the both side control electrodes 27 of a gap region 28, when the scanning image light moves from one of the both side control electrodes 27 to the other one, and therefore the optical capability of the gap region 28 is controlled in the visual state.

### REFERENCE SIGNS LIST

1 display apparatus
11 projector
21 screen
22 segmented region
25 optical layer
27 control electrode
28 gap region
31 synchronous controller (controller)
T scanning period
TP partial scanning period
Ton period including the visualizing period
Toff no visualizing period

1. A display apparatus comprising:
a screen having an optical layer whose optical state is changed by applying a voltage and a plurality of control electrodes arranged side by side and spaced therebetween along the optical layer to apply the voltage to the optical layer;
a projector configured to project image light on the screen to display an image; and
a controller configured to apply the voltage to the plurality of control electrodes, to switch the optical state of the screen by the unit of each of segmented regions corresponding to the each of the control electrodes, between a predetermined visual state in which the image light is scattered and a nonvisual state which is different from the visual state, in a projection period of the image light,
wherein, at a irradiation timing of the image light, the controller applies voltages with a same polarity to two of the control electrodes arranged next to one another, to control the optical state of a region between the two segmented regions.

2. The display apparatus according to claim 1, wherein:
the projector scans the screen with the image light;
the screen operates in a reverse mode in which a transmittance of parallel rays is lowered by applying the voltage, and scatters and transmits the irradiated image light; and,
when the scanning image light moves from one of the two segmented regions to the other, the controller applies voltages with a same polarity to the two control electrodes arranged next to one another, to control the optical state of a region between the two segmented regions.

3. The display apparatus according to claim 2, wherein, when the scanning image light moves from one of the two segmented regions to the other, the controller applies voltages with a same polarity and a same amplitude to the two control electrodes, to control the region between the two segmented regions in a visual state.

4. The display apparatus according to claim 2, wherein:
the controller adjusts and inverts an alternating voltage waveform which is applied to a part of the control electrodes to another alternating voltage waveform which is applied to another part of the control electrodes, so as for the applying voltage to the control electrodes corresponding to the two segmented regions to be in the same polarities at a scanning timing in which the region between the two segmented regions is scanned by the image light.

5. The display apparatus according to claim 2, wherein:
the controller:
applies voltages based on an alternating voltage waveform to the plurality of control electrodes; and
adjusts pulse width or a number of cycles of the alternating voltage waveform and applies the adjusted one to the plurality of control electrodes, so as for the applying voltages to the control electrodes corresponding to the both side segmented regions to be in the same polarities at the scanning timing, at which the region between the two segmented regions is scanned with the image light.

6. The display apparatus according to claim 4, wherein the controller adjusts the alternating voltage waveforms applied to the plurality of control electrodes, based on at least one of a scanning period of the image light and a frequency of the alternating voltage applied to the plurality of control electrodes.

7. The display apparatus according to claim 1, wherein:
the projector scans the screen with the image light;
the screen is operated in a normal mode in which a transmittance of parallel rays is increased by applying the voltage, and scatters and transmits the irradiated image light; and,
when the scanning image light moves from one of the two segmented regions to the other, the controller applies voltages with a same polarity to the two control electrodes arranged next to one another, to control the optical state of a region between the two segmented regions in a visible state.

8. A method of driving a display apparatus configured to display an image formed by image light irradiated from a projector, on a screen having an optical layer whose optical capability is changed by applying a voltage, the display apparatus including a controller that controls an optical state of the screen by:
applying the voltage to a plurality of control electrodes arranged side by side and spaced from each other along the optical layer, to display the image formed by the image light on the screen which has the plurality of control electrodes;
switching the optical state of the screen between a predetermined visual state to scatter the image light and a nonvisual state which is different from the visual state, by the unit of the segmented regions in accordance with the control electrodes, in the projection period of the image light;
controlling application and termination of the application of the voltages to the plurality of control electrodes in a scanning period of the image light, by switching each of states of the segmented regions corresponding to the control electrodes with the voltage applications, from a visual state in which the image light is scattered to a predetermined nonvisual state which is a different optical state thereof; and,
at an irradiation timing of the image light, applying the voltages with a same polarity to two control electrodes arranged next to one another, to control the optical state of a region between the two segmented regions.

9. A screen apparatus for displaying comprising:
a screen configured to display an image formed by projecting image light, the screen having an optical layer whose optical capability is changed by applying a voltage; and a plurality of control electrodes arranged side by side and spaced from each other along the optical layer to apply the voltage to the optical layer; and
a controller configured to apply and stop of the voltage to the plurality of control electrodes, and to switch the optical state of each of segmented regions corresponding with the control electrodes, between a predetermined visual state in which the image light is scattered and a nonvisual state which is different from the visual state,
wherein, at an irradiation timing of the image light, the controller applies the voltages with a same polarity to two control electrodes arranged next to one another to control the optical state of a region between the two segmented regions.

10. The display apparatus according to claim 5, wherein the controller adjusts the alternating voltage waveforms applied to the plurality of control electrodes, based on at least one of a scanning period of the image light and a frequency of the alternating voltage applied to the plurality of control electrodes.

11. The display apparatus according to claim 3, wherein:
the controller adjusts and inverts an alternating voltage waveform which is applied to a part of the control electrodes to another alternating voltage waveform which is applied to another part of the control electrodes, so as for the applying voltage to the control electrodes corresponding to the two segmented regions to be in the same polarities at a scanning timing in which the region between the two segmented regions is scanned by the image light.

12. The display apparatus according to claim 3, wherein:
the controller:
applies voltages based on an alternating voltage waveform to the plurality of control electrodes; and
adjusts pulse width or a number of cycles of the alternating voltage waveform and applies the adjusted one to the plurality of control electrodes, so as for the applying voltages to the control electrodes corresponding to the both side segmented regions to be in the same polarities at the scanning timing, at which the region between the two segmented regions is scanned with the image light.
